(19) United States
(12) Patent Application Publication
(10) Pub. No.: US 2003/0186008 A1
(43) Pub. Date: Oct. 2, 2003

(54) Spirally wound packages of soft thermoplastic elastomer tape, film, or sheet and processes for producing same

(76) Inventors: Stephen P. Sutton, Elkton, MD (US); William T. Sutton, Charleston, SC (US)

Correspondence Address: Timothy A. Cassidy, Dority & Manning, Attorneys at Law, P.A., P.O. Box 1449, Greenville, SC, 29602, US

(21) Appl. No.: 10/113,907

(22) Filed: Mar. 29, 2002

(51) Int. Cl. B32B 1/08

(52) U.S. Cl. 428/36.9; 428/906

(57) ABSTRACT

Soft thermoplastic elastomer articles in the form of spirally wound packages of tape, film, or sheet is disclosed. Packaging in this form enables use of extremely soft thermoplastic elastomers in a wide range of industrial, medical, and general consumer applications where conformable adherent materials are needed. Specifically, spirally wound packages of soft (under Shore A 28) thermoplastic elastomers are particularly valuable for application as grip wraps, anti-skid overlays, padding, elastic banding, and a wide variety of other uses requiring adherent or elastic materials. Beyond articles of manufacture, the invention provides manufacturing processes enabling production of extremely soft wound packages of thermoplastic elastomers in a practical framework.

### BACKGROUND OF THE INVENTION

In recent decades tremendous advances have occurred in the development of elastomers processible as thermoplastics. Today, a wide range of thermoplastic elastomers are commonly available which display physical cross-linking wherein block segments of thermoplastic polymer provide mechanical inter-linking of elastomeric molecules. Remarkably, many of these materials can be plasticized at high levels to achieve extreme levels of softness while retaining mechanical toughness and high elongation to failure. Chen, for example, in U.S. Pat. Nos. 5,508,337; 5,334,646; 5,262,468; 4,369,284, which are all incorporated herein by reference, describes plasticized compositions of high molecular weight styrene-ethylene-butylene-styrene block copolymers with good softness characteristics (at and below 00 Shore A hardness). Although chemically cross-linked elastomers can, in some cases, be formulated to achieve high levels of softness, thermoplastic elastomer compositions offer a unique combination of softness in combination with toughness and other mechanical characteristics.

Although a wide range of soft plasticized thermoplastic elastomer compositions are available commercially, intended applications are typically limited to injection and other forms of molding. This is especially true for thermoplastic elastomers having a Shore A hardness of below about 28. Although such elastomer compositions are commercially available from numerous sources, the products are commonly marketed as molding materials.

Very soft thermoplastic elastomer compositions, such as those having a Shore A hardness of less than about 28, are generally difficult to extrude using traditional thermoplastics extrusion techniques. Although behavior varies according to exact formulation and process temperature, profile extrusion of such compositions, in general, produces extremely fragile and difficult to handle extrudate. Of particular importance, a hot profile produced from these materials is typically susceptible to tearing if placed under slight tension, even for brief periods, during solidification and cooling to ambient temperatures. Additionally, many of these materials are highly fluidic at temperatures sufficient to achieve stable die flow, making molten profiles, at the onset of cooling, sticky and susceptible to deformation or destruction under the action of slight forces. Finally, ultimate cool profiles produced from such soft materials are inherently susceptible to great deformation under even the slightest tension. These complications are believed to have limited potential applications of these compositions in the past.

As such, a need currently exists for an improved process for extruding thermoplastic elastomers that have a relatively high level of softness. A need also exists for various products that can be produced by extruding highly soft thermoplastic elastomers. Such products could include, but are not limited to, grip wraps, anti-skip padding, general adherent elastic banding, and general purpose lightly adherent tape.

### SUMMARY OF THE INVENTION

The present invention is generally directed to novel spirally wound embodiments of soft (under Shore A 28) thermoplastic elastomers. Such soft thermoplastic elastomers, when extruded into a film according to the present invention, have been found to possess varying degrees of surface tackiness and/or friction. In particular, once formed into a film according to the present invention, it has been found that the surface of the film is so deformable that an air/vacuum seal, similar to that formed by a suction cup, immediately forms on contact with many surfaces. Thus, the films display light adhesion which is releasable, while providing moderate holding power through suction effects. Given the vacuum sealing and conformal characteristics of the films, such spirally wound embodiments enable convenient use of these materials in a wide range of important industrial, medical, and consumer applications.

In one embodiment, the present invention is directed to a product comprising a spirally wound elastic film. The film is made from a thermoplastic elastomer and has a durometer of less than about Shore A 28. In addition to a thermoplastic elastomer, the film can also contain a plasticizer, such as a mineral oil or napthanic oil. The plasticizer can be present within the film in an amount up to about 95% by weight, and particularly from about 30% to 70% by weight.

In general, any suitable thermoplastic elastomer can be used in the present invention. Examples of elastomers that can be used include, for instance, styrene-butadiene-styrene block copolymers, styrene-isoprene-styrene block copolymers, styrene-ethylene/butylene-styrene block copolymers, styrene-ethylene/propylene-styrene block copolymers, polyurethanes, polyetheresters and mixtures thereof. Suitable polyurethanes include, for instance, polyester polyurethanes.

The dimensions of the elastic film formed into the spirally wound roll can vary depending upon the particular application. For instance, in some applications, the film can be very narrow or can be very wide in the form of a sheet. For many applications, the width of the film can be from about 0.25 inches to about 3 inches. These ranges, however, are for exemplary purposes only.

Besides the width of the film, the thickness of the film can also vary depending upon the end use. In one embodiment, the thickness of the film can be from about 0.005 inches to about 0.3 inches and particularly from about 0.005 inches to about 0.1 inches. In one embodiment, for example, the thickness of the film can be from about 0.01 inches to about 0.07 inches.

The durometer of the film can vary as desired by selecting the particular thermoplastic elastomer combination and/or increasing or decreasing the amount of plasticizer. For example, the film can have a durometer of less than about Shore A 20, less than about Shore A 10, less than about Shore A 5, and, if desired, can have a durometer of down to about Shore A 00.

Such embodiments provide a soft and elastic type of material in a form appropriate for convenient unrolling in applications crossing a wide range of practical scenarios. The extremely soft and rubbery nature of the base material makes such a form ideal for unrolling to form custom elastic banding of all kinds. In addition, light adherence enables use of roll forms as an alternative to traditional adhesive tape to tack items and provide anti-skid surfaces. Finally, the ultra-conformability of the material allows use in roll form as a protective or grip wrap which is self sealing, soft, and lightly adherent.

Given these characteristics, the roll embodiments of the invention are useful in a very broad range of specific applications. Examples include: grip wraps for sports, grip wraps as aids for daily living, anti-skid padding, protective self sealing wrap, anti-chaffing protective wrap, non-adhesive adherent office tape, non-adhesive adherent elastic banding for packaging, and custom tied elastic banding. These examples, however, are in no way intended to limit the scope or breadth of possible applications.

The present invention is further directed to various forms of processing which allow practical production of spirally wound packages of soft thermoplastic elastomers.

In one embodiment, the process involves a method for the production of soft thermoplastic elastomer film, sheet, or tape through the melt extrusion of low viscosity material and immediate shock cooling of the resultant extrudate upon immediate exit from the die. This may be accomplished through a variety of techniques. For instance, in one embodiment, the extrudate is immediately submersed (within 1 second) in a quenching bath of fluid. The extrudate is quenched into a solid elastomeric form at a temperature appropriate for subsequent processing.

In one embodiment, a film is formed. According to the present invention, the film is wound as it emerges from the melt-quenching step (at a nearly ambient temperature), into a finished spirally wound roll. In typical tape extrusion processes winding would take place through the application of some moderate (or even large) torque to the winding roll. The extremely soft nature of the elastomers associated with the present invention, however, makes such an approach problematic. Even under the slightest tension (typically on the order of fractions of a pound for a tape 1 inch wide by 0.045 inches thick), dramatic elongation will occur and the resultant package will distort significantly as applied layers compress layers within. Consequently, according to the present invention, the soft thermoplastic elastomer is wound into finished rolls under relatively low tension.

### BRIEF DESCRIPTION OF THE DRAWING

FIG. 1 shows one embodiment of a process associated with the present invention.

### DETAILED DESCRIPTION

It is to be understood of one of ordinary skill in the art that the present discussion is a description of exemplary embodiments only, and is not intended as limiting the broader aspects of the present invention.

The spirally wound embodiments of the present invention are, most preferably, comprised of physically cross-linking thermoplastic elastomers which, through the use of various plasticizers, may be formulated to achieve very soft compositions (under a Shore A of 28). Although there are several general polymer families which fall into this category, among the most important are block copolymers of isoprene, butylene, ethylene/butylene, and ethylene/propylene with polystyrene end groups. Specific examples of such materials are the Kraton® D and Kraton® G series of resins sold by Kraton®, Inc., Santoprene® resins sold by Monsanto, and Norprene® resin sold by Norton, Inc. Such resins may typically be highly plasticized with oil and a wide range of other substances (even to extreme loadings in excess of 95 percent by weight of plasticizer) to achieve soft compositions with overall characteristics depending on molecular weight, polystyrene percentage, etc.

Plasticizing oils most preferable for use with these types of elastomeric block copolymers with polystyrene end groups are comprised of low aromatic content mineral and napthanic oils. Such oils are available from a variety of sources and in different grades of varying purity (extending to those suitable for food contact). Examples include, but are not limited to, the Duoprime® series of mineral oils sold by Lyondel Lubricants (70 through 500). Less pure non-FDA grades are also suitable for use in embodiments of the invention but are less preferable particularly in applications wherein finished articles are intended for potential skin contact.

As one skilled in the art will recognize, a variety of other thermoplastic elastomer polymer families exist which, in some cases, may be highly plasticized to achieve soft compositions appropriate for use in embodiments of the present invention. Specifically, thermoplastic polyurethanes such as Dow Pellethane®, polyester based thermoplastic elastomers such as DuPont-Dow Elastomers Division, Hytrel® and even EVA such as DuPont, Elvax® can all be used to produce specific embodiments of the present invention. In addition, blends of different types of these polymers, and plasticizers, may be used to produce embodiments of the invention. In general, any thermoplastic elastomer or blend of thermoplastic elastomers and/or other polymers which may be sufficiently plasticized with a wide range of substances to achieve a Shore A hardness under 28, may be utilized in connection with specific embodiments of the invention.

Processing of such materials to produce spirally wound articles of the invention typically begins with the formulation of the required polymer and plasticizer ingredients. A specific polymer and plasticizer blend is typically produced through a variety of techniques depending on the required scale of manufacture. On a small custom manufacturing or developmental scale, a masterbatch of the ingredients may be hand mixed in a small vessel and directly extruded using a twin or single screw system with some degree of distributive mixing capability to insure homogeneous plasticization. On a larger scale, ingredients may be masterbatched and thoroughly blended using blenders such as those offered commercially by Patterson-Kelly prior to twin or single screw extrusion with dispersive mixing. In some cases, plasticizer and polymer may be precision fed directly into the extruder system and directly blended within.

One skilled in the art is aware that pre-blending and melt mixing of the polymer compound may either be carried out in a compounding process prior to the extrusion process utilized to produce tape, film, or sheet, or through integration and linking of all associated steps. Most preferably, however, the melt blending of constituents is carried out on a large scale and the resultant polymer is pelletized (either utilizing an underwater or stand chopping system) to produce an intermediate compound for subsequent extrusion and conversion into articles of the invention.

To produce specific embodiments of the present invention, blending and pelletization of the polymer compound may be accomplished, in whole or in part, through the use of proprietary pre-blended and pelletized compounds sold commercially. These include the soft Dynaflex® series of compounds sold by GLS corporation (very soft grades include G6713, G6708, and G603), in addition to a variety of specialty compounds sold by Geon Corporation, Star Polymers Corporation, and other compounders. Such compounds, may be selected and directly extruded to produce embodiments of the present invention, or additionally blended with plasticizers or other materials to enhance various aspects of the final product.

One skilled in the art will further recognize that formulations associated with the present invention may incorporate a wide variety of minor components in addition to the base polymer and associated plasticizer. Any number of additives including, but not limited to, flame retardants, UV inhibitors, and wax or silicone (to modify surface properties), may be incorporated. Any type of pigmentation may also be employed to impart a desired coloration in finished articles. Finally, various types of particulate fillers may be incorporated to modify physical properties as desired. Additives incorporated therein, however, which modify the hardness beyond a Shore A hardness of 28 are beyond the scope of the present invention. Blending of such additional constituents may take place as an integral part of any of the steps described above, or separately, with similar methodology.

The extrusion of a compound into tape, film, or sheet is accomplished through completion of the steps outlined above, either integrated with, or prior to, extrusion using a twin or single screw system to feed an appropriate extrusion die. Depending on the exact geometry of the desired extrudate, the die may possess geometries including, but not limited to, those ranging from simple slot designs for production tape, to advanced variable land length systems (such as those offered commercially by Cloeren Inc. and EDI inc.). Most preferably, the die system and operational conditions chosen will produce a uniform rectangular output with roughly constant output velocity across the transverse direction. In addition, operational conditions are preferably chosen such that the temperature of the exiting material is sufficient to insure good fluidic flow without rubbery viscoelastic effects such as sharkskin, frayed or lasagna edges, etc.

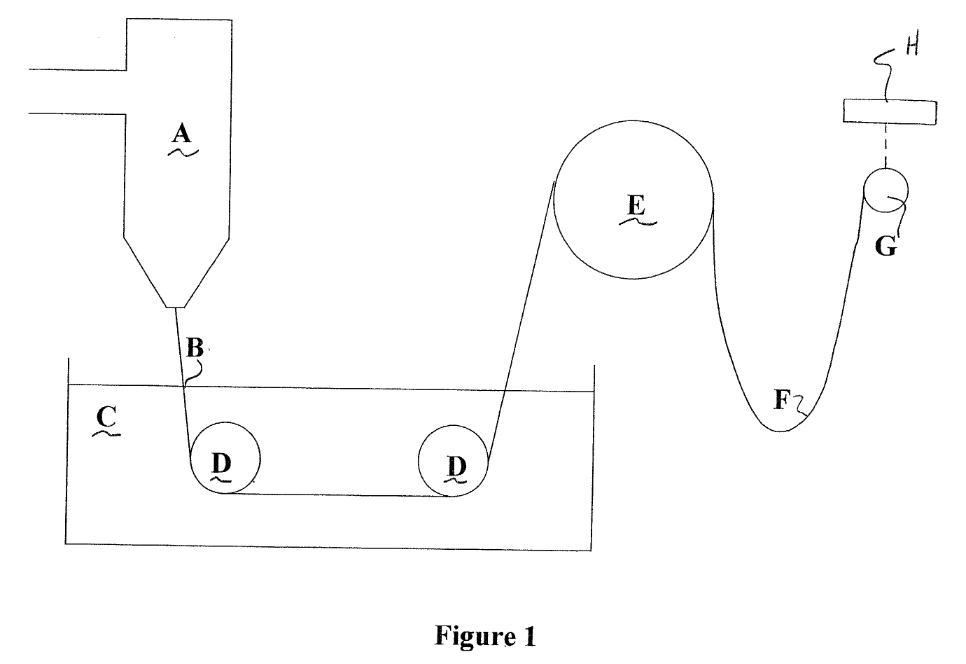

In one aspect of the present invention the fluid material extruded by the die is immediately quenched, to lower its temperature near ambient prior to subsequent processing. In the most preferred embodiment of this method, the low viscosity thermoplastic elastomer compound melt is extruded directly into a quenching fluid as shown in FIG. 1. Provided the fluid surface is placed in sufficient proximity to the die exit (most preferably with the die oriented vertical down), the fluidic melt may be quenched into an appropriate geometry notwithstanding its fragility. Upon entering the fluid, a virtually instantaneous quenching is achieved, thus preventing subsequent instability. The material is pulled under the water over a submerged idler roll (or series of idler rolls) by a driven constant speed friction roll which pulls the material out of the water and maintains a specific line speed.

In another embodiment of this process, the material may be extruded directly onto a driven roll which is either sufficiently cold to cause efficient quenching, or which is partially submerged in water such that molten material on the roll surface is dragged into the water and immediately quenched. Such a process, although workable, tends to be more problematic than direct water quenching for a number of reasons. First, a very cold roll tends to collect water condensation unless utilized in an extremely low humidity environment (which presents other difficulties) and a partially submerged roll will inevitably collect small water droplets. Such droplets, if left on the roll surface, contact freshly extruded material and partially vaporize, resulting in unwanted surface texturing. Although elaborate means can be provided to eliminate such droplets (air jets, etc.) most are typically not robust and inconvenient for practical use. Direct water quenching eliminates such problems and typically provides an extremely desirable smooth surface finish.

Although it is also possible to accomplish the required quenching by extrusion onto a quench roll large enough to insure complete cooling before the material emerges from its surface, or at sufficiently slow line speed to insure complete cooling, it is important to recognize the delicate nature of thermoplastic elastomers which, although in a solid state, are warm relative to ambient temperature. Unless the material is completely cool prior to any subsequent handling (even under purely the action of gravity), breakage is likely. In addition, unless the material is cooled to near ambient prior to wrapping on itself, there is the risk of unwanted bonding of over-wrapped layers. For these reasons, immediate water quenching, or even a very cold quench roll, are superior alternatives. Otherwise, linespeed may be severely limited by the path length along the quench roll surface.

In yet another aspect of the present invention, cool material is wound (at a nearly ambient temperature), into a finished spirally wound roll under extremely low tension. Among the simplest methods for accomplishing low-tension winding is to allow the material emerging from the quenching process to fall a short distance into an open pan or container. Surprisingly, typical extruded forms of the invention, purely under gravity, will typically gravity fold and stack to produce containers of material which may be reversibly unfolded for hand spooling. Provided the material was cool during the stacking process, removal is easily accomplished by pulling the material from its end, to result in a continuous, tangle free, reverse order material flow. Hand spooling on a core may then be accomplished through a variety of techniques using hand cranked winding fixtures. Importantly, with human control, the winding process can be accomplished through light laying on of successive spiral wraps, to produce a finished, and substantially stress free, wound article.

Although hand winding is a viable production technique to produce articles of the invention, an automated process may be preferred in some applications. For machine driven winding, however, it is necessary to provide a mechanism for controlling very small tensions within a narrow tolerance.

One facet of the present invention is comprised of a numerical or analog spool winding system which controls the exact speed at which the winding spool turns to insure material is wound onto the spool a predetermined rate relative to the output of the quenching system. Provided this is accomplished with high precision, the material emerging from the driven friction roll (at constant line speed) at the quench stage may hang suspended in a well-defined fashion until it reaches the spool. Provided the rate of material winding is properly balanced to the friction roll speed, the resultant arc of material will remain unchanged (to within some tolerance) during the winding of a spool as shown in FIG. 1. Since the weight of the material and the form of the resultant arc provide a small tension for winding, the result is a spooling system which provides high precision control of winding tension.

Referring to FIG. 1, one embodiment of a process in accordance with the present invention is illustrated. As shown, the system includes an extrusion die A for receiving a supply of a composition containing at least one thermoplastic elastomer and, if desired, a plasticizer. As described above, various other ingredients can also be present within the composition. As shown, the extrusion die A continuously produces a film B made from the thermoplastic elastomer. The thickness of the film that is formed can vary depending upon the particular application. For most embodiments, the film will have a thickness of from about 0.005 inches to about 0.1 inches.

Once the film is formed, the film is immediately submerged or contacted with a quenching medium C. The quenching medium can be, for instance, water at ambient temperatures. In general, the film should contact the quenching medium within about 1 second from leaving the extruder, particularly within ½ second, and more particularly within ¼ second from exiting the extruder. Once in the quenching medium, the temperature of the film is quickly reduced. For instance, the temperature of the film can be reduced to a temperature of less than about 60° C., and particularly less than about 40° C.

In the embodiment illustrated in FIG. 1, the film B passes over two submerged idler rolls D and pulled from the bath containing the quenching medium by a driven friction roll E. The material is then allowed to hang in a free arc F as it is wound onto a spool G.

In one embodiment, as shown in FIG. 1, the system can further include a controller H, such as a microprocessor or computer. The controller can be used to control and calculate, at any given instant, the angular velocity at which the spool must turn in order to achieve a given material winding speed. In this embodiment, the system can cause the spool to turn at a non-constant (progressively slowing) angular rate which maintains an arc of hanging material between the friction roll and the winding spool.

Provided the center of the friction roll and winding spool are horizontally aligned (as shown in FIG. 1), and the ultimate diameter of the wound article is small relative to the distance separating these centers, the tension resulting from the hanging arc of material is accurately maintained by insuring a constant material winding rate equal to (or as will be discussed slightly in excess of) the friction roll surface speed. Although slight changes still occur in arc form with growing roll diameter (since the unsupported chord length between points A and B in FIG. 1 changes with roll diameter), the small effect on tension can typically be neglected. Given this, the spool angular frequency, f, may be maintained according to the relationship:

f=v/(πD)

where v is the surface speed of the friction roll and D is the instantaneous diameter of the spool. As one skilled in the art will recognize, D may either be numerically calculated as a function of time (given the thickness of the material being wound) or measured through appropriate instrumentation.

A wide range of different schemes may be used to implement this spool speed profile (open loop or closed loop), all of which are embodiments of the winding process associated with the invention. Examples include, but are in no way limited to: 1) computer calculation of the required speed and output of a digital control signal to yield in this speed using a stepper motor and computer calculation of the required speed and 2) feedback driven control of a servo motor to achieve that speed. Obviously, such a system may actively measure the friction roll line speed, the roll diameter, and/or other important parameters to determine the instantaneous desired roll angular frequency, or may simply calculate the instantaneous target based on preset values. Also, compensation for changes in arc form resulting from increasing spool diameter, even in the case of non-horizontally aligned friction roll and spool centers, may be incorporated. In addition, there is no absolute constraint that the tension profile be maintained purely constant and, in some cases, a non-constant roll takeoff speed may be used to vary tension somewhat during winding. In any case, systems which accurately match the rate of material takeoff onto the spool, in order to control hanging tension, are embodiments of the invention.

In general, during operation, this spool winding system will produce successive rolls which may be removed from the system prior to the initiation of a new winding cycle. For this reason, it is desirable that the spooling system wind material at a rate slightly in excess of the friction roll surface speed. This causes some change in arc height and arc length over the course of a given cycle but, in general, resultant changes in tension have limited effect. More importantly, the resultant mismatch in speed compensates for the time required for roll changeover, and eliminates the necessity to cut some portion of material at the end of each cycle to prevent the arc length from increasing.

The various aspects of the present invention are further illustrated by means of the following specific embodiments, which are given only for the purpose of illustration and are not meant to limit the scope of the present invention.

In all of the examples to follow, a standard Entwhistle 1.5 inch single screw extruder was used. This extruder provides temperature control in three separate zones down the length of the barrel (roughly corresponding to feed, compression, and metering zones along the screw), as well as temperature control for the die head flange, the die coupling transition, and the die itself. Henceforth, each of these 6 control areas are referred to zones 1-6, respectively. The screw utilized for all trials was relatively standard for general thermoplastics resin extrusion, having constant pitch flights, and feed, compression, and metering zones arranged in three roughly equal segments. The metering zone was equipped with a barrier flight dispersive mixing element. The depth of flights in the compression zone was 0.275 inches compressing to an output depth of 0.125 inches. The die utilized in all trials was a simple slot die, having a constant depth fan shaped melt cavity 0.100 inches deep by 3.75 inches in length by 1.25 inches in width. The land in this die was rectangular being 1.25 inches in width by 0.75 inches in length. The upper half of this land is adjustable from a fully closed position to an output depth of 0.100 inches. Extruded tape was fed directly into a water bath maintained at room temperature as depicted in FIG. 1.

### EXAMPLE 1

The following process was used to produce a tape comprising a thermoplastic elastomer with durometer equal to Shore A 20. One pound of Kraton® G 1650 thermoplastic elastomer was combined with 1 pound of medical grade mineral oil manufactured by Quality Choice into a 5-gallon container. The constituents were hand-mixed with a paddle for several minutes until an oil-wet slurry was achieved. The composite of thermoplastic elastomer and mineral oil was then allowed to dwell at ambient conditions for 30 minutes. The composite was then hand mixed for 2 to 5 minutes with a paddle and fed into the extruder.

The thermal profile of the extruder was as follows.

| Zone | Temperature |
|---|---|
| 1 | 190° C. |
| 2 | 190° C. |
| 3 | 190° C. |
| 4 | 190° C. |
| 5 | 190° C. |
| 6 | 190° C. |

An extrusion screw speed of 2.5 rpm was employed. The extrusion pressure was observed to be 55 psi on average. The die land opening was adjusted and sufficient pull-through draw was employed to produce a tape of 0.8 inch width and 0.045 inch thickness with a durometer measured as Shore A 20.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 2

The following process was used to produce a tape comprising a TPE with durometer equal to Shore A 7. One pound of Kraton® G 1650 thermoplastic elastomer was combined with 2 pounds of mineral oil manufactured by Quality Choice. The constituents were mixed as described in example 1. The extruder thermal profile was as follows.

| Zone | Temperature |
|---|---|
| 1 | 150° C. |
| 2 | 150° C. |
| 3 | 150° C. |
| 4 | 150° C. |
| 5 | 150° C. |
| 6 | 150° C. |

An extrusion screw speed of 5.0 rpm was employed. The extrusion pressure was observed to be 50 psi on average. The die land opening was adjusted and sufficient pull-through draw was employed to produce a tape of 0.8 inch width and 0.045 inch thickness with a durometer measured as Shore A 7.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 3

The following process was used to produce a tape comprising a thermoplastic elastomer with durometer equal to Shore A 25. Kraton® G 1650 thermoplastic elastomer was hand screened through a 12-mesh screen. One-half pound of the fine fraction of Kraton® G1650 resulting from said screening procedure was combined with 0.5 pounds of Duoprime® 70 oil obtained from Lyondell Lubricants of Tulsa, Okla. The constituents were mixed as described in example 1.

The thermal profile of the extruder was as follows:

| Zone | Temperature |
|---|---|
| 1 | 90° C. |
| 2 | 150° C. |
| 3 | 150° C. |
| 4 | 150° C. |
| 5 | 150° C. |
| 6 | 150° C. |

An extrusion screw speed of 10.0 rpm was employed. The extrusion pressure was observed to be 250 psi on average. The die land opening was adjusted and sufficient pull-through draw was employed to produce a tape of 0.8 inch width and 0.045 inch thickness with a durometer measured as Shore A 25.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 4

The following process was used to produce a tape comprising a thermoplastic elastomer with durometer equal to Shore A 5. One-half pound of Kraton® G 1650 thermoplastic elastomer was combined with 0.5 pounds of Duoprime® 500 oil obtained from Lyondell Lubricants. The constituents were mixed as described in example 1.

The thermal profile of the extruder was as follows.

| Zone | Temperature |
|---|---|
| 1 | 90° C. |
| 2 | 150° C. |
| 3 | 150° C. |
| 4 | 150° C. |
| 5 | 150° C. |
| 6 | 150° C. |

An extrusion screw speed of 5.0 rpm was employed. The die land opening was adjusted an sufficient pull-through draw was employed to produce a tape of 0.8 inch width and 0.045 inch thickness with a durometer measured as Shore A 5.

### EXAMPLE 5

The following process was used to produce a tape comprising thermoplastic elastomer with durometer equal to Shore A 13. One-half pound of Kraton® G 1650 was combined with 0.75 pounds of Duoprime® 70 oil. The constituents were mixed as described in example 1.

The thermal profile of the extruder was as follows.

| Zone | Temperature |
|---|---|
| 1 | 90° C. |
| 2 | 150° C. |
| 3 | 150° C. |
| 4 | 150° C. |
| 5 | 150° C. |
| 6 | 150° C. |

An extrusion screw speed of 10.0 rpm was employed. The extrusion pressure was observed to be 50 psi on average. Sufficient pull-through draw was employed to produce a tape of 0.8 inch width and 0.045 inch thickness with a durometer measured as Shore A 13.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 6

The following process was used to produce a tape comprising a thermoplastic elastomer with durometer equal to Shore A 00. One-half pound of Kraton® G 1651 thermoplastic elastomer was combined with 1.0 pounds of Duoprime® 70 oil. The constituents were mixed as described in example 1.

The thermal profile of the extruder was as follows.

| Zone | Temperature |
|---|---|
| 1 | 90 C |
| 2 | 150 |
| 3 | 150 |
| 4 | 150 |
| 5 | 150 |
| 6 | 220 |

An extrusion screw speed of 2.0 rpm was employed. The extrusion pressure was observed to be 90 psi on average. The die land opening was adjusted and sufficient pull-through draw was employed to produce a tape of 0.8-inch width and 0.045-inch thickness with a durometer measured as Shore A 00.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 7

The following process was used to produce a tape comprising a thermoplastic elastomer with durometer equal to Shore A 00. One pound of Kraton® G 1651 thermoplastic elastomer was combined with 2.0 pounds of Duoprime® 500 oil. The constituents were mixed as described in example 1.

The thermal profile of the extruder was as follows.

| Zone | Temperature |
|---|---|
| 1 | 90° C. |
| 2 | 210° C. |
| 3 | 235° C. |
| 4 | 235° C. |
| 5 | 235° C. |
| 6 | 235° C. |

An extrusion screw speed of 20.0 rpm was employed. The extrusion pressure was observed to be 370 psi on average. The die land opening was adjusted and sufficient pull-through draw was employed to produce a tape of 0.8-inch width and 0.045-inch thickness with a durometer measured as Shore A 00.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 8

The following process was used to produce a tape comprising a thermoplastic elastomer with durometer equal to Shore A 3. Three constituent fractions including 0.3 pounds of Kraton® G 1650 thermoplastic elastomer, 0.7 pounds of Kraton® G 1651 thermoplastic elastomer and 2.0 pounds of Duoprime® 500 were combined. The three constituents were mixed as described in example1.

The thermal profile of the extruder was as follows.

| Zone | Temperature |
|---|---|
| 1 | 90° C. |
| 2 | 210° C. |
| 3 | 230° C. |
| 4 | 230° C. |
| 5 | 230° C. |
| 6 | 230° C. |

An extrusion screw speed of 10.0 rpm was employed. The extrusion pressure was observed to be 280 psi on average. The die land opening was adjusted and sufficient pull-through draw was employed to produce a tape of 0.8 inch width and 0.045 inch thickness with a durometer measured as Shore A 3.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 9

Dynaflex® CL2000 resin, provided by GLS Corporation, was fed directly into the extruder without modification.

The thermal profile of the extruder was as follows:

| Zone | Temperature |
|---|---|
| 1 | 150° C. |
| 2 | 150° C. |
| 3 | 150° C. |
| 4 | 150° C. |
| 5 | 150° C. |
| 6 | 150° C. |

An extrusion screw speed of 10.0 RPM was employed. The extrusion pressure was observed to be 180 PSI on average. The die land opening and sufficient pull-through draw was employed to produce a tape of 0.8 width and 0.045 inch thickness with a durometer measured as Shore A 3.

The material produced by the friction roll was allowed to droop under gravity to produce a tape arc extending approximately 1 foot below the centerline between the friction roll and take off spool. The friction roll and take off spool centers were horizontally aligned and separated by a distance of approximately 1.5 feet.

The take off spool was wound on a ¾ inch wide plastic core 0.875 inches in diameter. The speed of rotation was numerically controlled by a computer driving a stepper motor. The computer utilized an algorithm which calculated the instantaneous desired angular speed by predicting the roll diameter assuming a tape thickness of 0.045 inches and a perfect spiral wrap geometry. Based on this instantaneous diameter, the output control signals produced a decreasing angular speed conforming to the relationship

f=v/(πD)

where v was a constant take up velocity and D the instantaneous roll diameter.

The take up velocity, v, was set to a value of 9.5 feet per minute. This speed was slightly greater than the surface speed of the friction roll. This caused a slight decrease in the droop height of the tape during the production of a spool allowing the operator to cut the tape, remove a finished spool, install a new core, and initiate a new cycle without loss of material. The computer was set up to produce wound rolls with a diameter of 3.0 inches and stop to await initiation of a new cycle on command by the operator. 50 spirally wound rolls were produced by the operator through initiation of successive cycles.

### EXAMPLE 10

Dynaflex® G6708 resin, provided by GLS Corporation, was fed directly into the extruder without modification.

The thermal profile of the extruder was as follows:

| Zone | Temperature |
|---|---|
| 1 | 170° C. |
| 2 | 170° C. |
| 3 | 170° C. |
| 4 | 170° C. |
| 5 | 170° C. |
| 6 | 170° C. |

An extrusion screw speed of 10.0 RPM was employed. The extrusion pressure was observed to be 230 PSI on average. The die land opening and sufficient pull-through draw was employed to produce a tape of 0.8 width and 0.045 inch thickness with a durometer measured as Shore A 7.

The material produced by the friction roll was allowed to droop under gravity to produce a tape arc extending approximately 1 foot below the centerline between the friction roll and take off spool. The friction roll and take off spool centers were horizontally aligned and separated by a distance of approximately 1.5 feet.

The take off spool was wound on a ¾ inch wide plastic core 0.875 inches in diameter. The speed of rotation was numerically controlled by a computer driving a stepper motor. The computer utilized an algorithm which calculated the instantaneous desired angular speed by predicting the roll diameter assuming a tape thickness of 0.045 inches and a perfect spiral wrap geometry. Based on this instantaneous diameter, the output control signals produced a decreasing angular speed conforming to the relationship

f=v/(πD)

where v was a constant take up velocity and D the instantaneous roll diameter.

The take up velocity v was set to a value of 9.5 feet per minute. This speed was slightly greater than the surface speed of the friction roll. This caused a slight decrease in the droop height of the tape during the production of a spool allowing the operator to cut the tape, remove a finished spool, install a new core, and initiate a new cycle without loss of material. The computer was set up to produce wound rolls with a diameter of 3.0 inches and stop to await initiation of a new cycle on command by the operator. 50 spirally wound rolls were produce by the operator through initiation of successive cycles.

### EXAMPLE 11

Dynflex G6703 resin, provided by GLS Corporation (a highly plasticized SEBS thermoplastic elastomer with a bulk shore A hardness of 3), was blended with Hytrel 3078 resin (a polyetherester), provided by Dupont-Dow Elastomers Division. The Hytrel material was first dried at temperature of 105 degrees Celsius for period in excess of 12 hours.

488 grams of G6703 resin pellets were hand blended in a bucket with 12 grams of Hytrel 3078 resin. The resultant blend was fed directly into the extruder without modification.

The thermal profile of the extruder was as follows:

| Zone | Temperature |
|---|---|
| 1 | 210° C. |
| 2 | 210° C. |
| 3 | 210° C. |
| 4 | 210° C. |
| 5 | 210° C. |
| 6 | 210° C. |

An extrusion screw speed of 10.0 RPM was employed. The extrusion pressure was observed to be 165 PSI on average. The die land opening was adjusted and sufficient pull-through draw was employed to produce a tape of 0.8 inches width and 0.045 inch thickness with a durometer measured as Shore A 7.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

### EXAMPLE 12

Dynflex G6703 resin, provided by GLS Corporation, was blended with Hytrel 3078 resin, provided by Dupont-Dow Elastomers Division. The Hytrel material was first dried at temperature of 105 degrees Celsius for period in excess of 12 hours.

450 grams of G6703 resin pellets were hand blended in a bucket with 50 grams of Hytrel 3078 resin. The resultant blend was fed directly into the extruder without modification.

The thermal profile of the extruder was as follows:

| Zone | Temperature |
|---|---|
| 1 | 210° C. |
| 2 | 210° C. |
| 3 | 210° C. |
| 4 | 210° C. |
| 5 | 210° C. |
| 6 | 210° C. |

An extrusion screw speed of 10.0 RPM was employed. The extrusion pressure was observed to be 110 PSI on average. The die land opening was adjusted and sufficient pull-through draw was employed to produce a tape of 0.8 inches width and 0.045 inch thickness with a durometer measured as Shore A 7.

The tape emerging from the friction roll was allowed to fall approximately 2 feet into a stainless steel pan. This produced a neatly folded pile of material. Subsequently, this tape was pulled in reverse order from this pile and spooled by hand, using a hand cranked fixture, onto a 0.875 inch diameter by 0.75 inch wide core to produce 2 spirally wound spools approximately 3 inches in diameter.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A product comprising:
a spirally wound elastic film, the film comprising a thermoplastic elastomer, the film having a durometer of less than about Shore A 28.

2. A product as defined in claim 1, wherein the film has a width of from about 0.25 inches to about 3 inches.

3. A product as defined in claim 1, wherein the film has a thickness of from about 0.005 inches to about 0.1 inches.

4. A product as defined in claim 3, wherein the film has a width of from about 0.25 inches to about 3 inches.

5. A product as defined in claim 1, wherein the film has a thickness of from about 0.01 inches to about 0.07 inches.

6. A product as defined in claim 1, wherein the film has a durometer of less than about Shore A 20.

7. A product as defined in claim 1, wherein the film has a durometer of less than about Shore A 10.

8. A product as defined in claim 1, wherein the film has a durometer of from about Shore A 00 to about Shore A 10.

9. A product as defined in claim 1, wherein the thermoplastic elastomer comprises a styrene-butadiene-styrene block copolymer or a styrene-isoprene-styrene block copolymer.

10. A product as defined in claim 1, wherein the thermoplastic elastomer comprises a styrene-ethylene/butylene-styrene block copolymer.

11. A product as defined in claim 1, wherein the film further comprises a plasticizer.

12. A product as defined in claim 1, wherein the thermoplastic elastomer comprises a styrene-ethylene/propylene-styrene block copolymer.

13. A product as defined in claim 1, wherein the thermoplastic elastomer comprises a polyurethane.

14. A product as defined in claim 10, wherein the plasticizer comprises a mineral oil, the film containing the plasticizer in an amount from about 30% to about 70% by weight.

15. A product comprising:
a wound roll of elastic tape, the tape comprising a film made from a thermoplastic elastomer and a plasticizer, the film having a durometer of less than about Shore A 28, the thermoplastic elastomer comprising a styrene-isoprene-styrene block copolymer, a styrene-butadiene-styrene block copolymer, a styrene-ethylene/butylene-styrene block copolymer, a styrene-ethylene/propylene-styrene block copolymer, a polyurethane, or mixtures thereof, the tape having a thickness of from about 0.005 inches to about 0.1 inches.

16. A product as defined in claim 14, wherein the tape has a width of from about 0.25 inches to about 3 inches.

17. A product as defined in claim 14, wherein the film has a durometer of less than about Shore A 10.

18. A product as defined in claim 14, wherein the film has a durometer of less than about Shore A 5.

19. A product as defined in claim 14, wherein the thermoplastic elastomer comprises a styrene-ethylene/butylene-styrene block copolymer.

20. A product as defined in claim 14, wherein the plasticizer is present within the film in an amount from about 30% to about 70% by weight.

21. A process for producing a wound elastic tape product comprise the steps of:
extruding an elastomeric composition into a film, the elastomeric composition comprising a thermoplastic elastomer and a plasticizer;
quenching the formed film in a quenching medium; and
winding the film into a roll, the film having a durometer of less than about Shore A 28.

22. A process as defined in claim 20, wherein the thermoplastic elastomer comprises a styrene-isoprene-styrene block copolymer, a styrene-butadiene-styrene block copolymer, a styrene-ethylene/butylene-styrene block copolymer, a styrene-ethylene/propylene-styrene block copolymer, a polyurethane, or mixtures thereof.

23. A process as defined in claim 20, wherein the thermoplastic elastomer comprises a styrene-ethylene/butylene-styrene block copolymer.

24. A process as defined in claim 20, wherein the film has a thickness of from about 0.005 inches to about 0.1 inches.

25. A process as defined in claim 20, wherein the film has a width of from about 0.25 inches to about 3 inches.

26. A process as defined in claim 20, wherein the film has a durometer of less than about Shore A 10.

27. A process as defined in claim 20, wherein the film has a durometer of from about Shore A 00 to about Shore A 10.

28. A process as defined in claim 20, wherein the elastomeric composition is extruded at a temperature of from about 100° C. to about 250° C.

29. A process as defined in claim 20, wherein the quenching medium comprises water.

30. A process as defined in claim 20, wherein the film is quenched to a temperature of less than about 60° C.

31. A process as defined in claim 20, wherein the film is quenched to a temperature of less than about 40° C.

32. A process as defined in claim 20, wherein the film is submerged in the quenching medium within 1 second after being extruded.

33. A process as defined in claim 20, wherein the film is wound onto a spool that is a part of a numerical or analog winding system.

34. A process as defined in claim 20, wherein the film is guided around a driven roll after exiting the quenching medium and wound onto a spool.

35. A process as defined in claim 20, wherein the film is wound on a driven spool in operative association with a controller, and wherein the controller is configured to adjust the angular velocity of the driven spool in relation to the velocity of the film exiting the quenching medium and the diameter of the formed roll so as to maintain relatively low tension in the film.

36. A process as defined in claim 20, wherein the film is wound onto a spool that has a gradually decreasing angular velocity as the diameter of the formed roll increases.

37. A process as defined in claim 20, wherein the film is wound under tension substantially no greater than that imposed by gravity.
